(19) United States
(12) Patent Application Publication
(10) Pub. No.: US 2026/0163884 A1
(43) Pub. Date: Jun. 11, 2026

(54) SYSTEMS AND METHODS FOR SECURING COMMUNICATION SESSIONS

(71) Applicant: CyberArk Software Ltd., Petach-Tikva (IL)

(72) Inventors: Asaf HECHT, Petach-Tikva (IL); Roy Ben YOSEF, Petach-Tikva (IL); Jason YOKOTA, Petach-Tikva (IL)

(73) Assignee: CyberArk Software Ltd., Petach-Tikva (IL)

(21) Appl. No.: 18/973,774

(22) Filed: Dec. 9, 2024

(51) Int. Cl. H04L 9/40

(52) U.S. Cl. CPC H04L 63/0884; H04L 63/126; H04L 63/20

(57) ABSTRACT

Disclosed herein are techniques for securing a real time communication session between at least two computing devices. Operations may include monitoring the communication session between the at least two computing devices associated with an organizational communication security service, validating, by the organizational communication security service, the communication session, determining, by the organizational communication security service, a security status of the communication session based on the real-time validation of the communication session, and performing, by the organizational communication security service, a security action based on the security status.

### FIELD OF DISCLOSURE

The disclosed embodiments generally relate to systems, devices, methods, and computer-readable media for securing a real time communication session between at least two computing devices.

### BACKGROUND

With the increased use of online communications, such as video calls, virtual meetings, and other communication sessions, hackers have identified new opportunities to steal network identity authentication information. For example, an attacker may use a variety of methods, such as artificial intelligence and deepfake technology, to realistically impersonate real people during online communication sessions, such as video or audio calls. An attacker may initiate a communication session with one user impersonating another user in an effort to steal personal, confidential, or financial information. The attacker may steal authentication information, financial information, or other confidential information by realistically impersonating someone known to the user during a communication session. Such attackers may further compromise passwords, compromise endpoint computing devices, and steal tokens and/or cookies during such attacks. Because artificial intelligence and deepfake technology allow attackers to create realistic impersonations, it may be difficult for a user to accurately identify whether another user is a real person or an impersonation. Further, communication sessions may not provide a user with an authentication system to verify the identity of other users participating in the communication session.

Therefore, to address these technical deficiencies in securing communication sessions, solutions should be implemented to secure communication sessions between at least two computing devices in real time. Such solutions should monitor a communication session between at least two users. An organizational communication security service should validate the communication session based on a variety of factors to ensure that the users participating in the communication session are valid and authenticated users. For example, such solutions should validate both the content of the communication session and data associated with the communication session. Such solutions should further allow a user to transmit an authentication request to another user on a communication session and receive a response to the authentication request displayed through a graphical user interface. These and other technological improvements and advantages are discussed below.

### SUMMARY

The disclosed embodiments describe non-transitory computer readable media and computer implemented methods for securing a real time communication session between at least two computing devices. For example, in an embodiment, a non-transitory computer readable medium may include instructions that, when executed by at least one processor, may cause the at least one processor to perform operations for securing a real time communication session between at least two computing devices. The operations may comprise monitoring the communication session between the at least two computing devices associated with an organizational communication security service, validating, by the organizational communication security service, the communication session based on an analysis of content of the communication session and at least one of: data from an agent installed on at least one of the at least two computing devices, a comparison to a communication profile associated with at least one network identity participating in the communication session, or at least one secret associated with the at least one network identity participating in the communication session, determining, by the organizational communication security service, a security status of the communication session based on the real-time validation of the communication session, and performing, by the organizational communication security service, a security action based on the security status.

According to a disclosed embodiment, the analysis of the content of the communication session may comprise analyzing the content of the communication session using a pre-trained machine learning model.

According to a disclosed embodiment, the analysis of the content of the communication session may further comprise using context data associated with at least one participant of the communication session in combination with the pre-trained machine learning model.

According to a disclosed embodiment, analyzing the content of the communication session may comprise enforcement of an organizational security policy.

According to a disclosed embodiment, the agent may comprise one of a browser component or an endpoint management software.

According to a disclosed embodiment, the organizational communication security service may be implemented on at least one of: a cloud environment, at least one computing device of the at least two computing devices, the agent, an add-on to a computer program associated with the communications session, or a browser component.

According to a disclosed embodiment, validating the at least one secret may comprise determining when the at least one secret was assigned and if the at least one secret is rightfully assigned.

According to a disclosed embodiment, the communication session may be a video call.

According to a disclosed embodiment, the analysis of the content of the communication session may comprise comparing a first video frame sent from a first client device and a second video frame received by a second client device.

According to a disclosed embodiment, comparing the first video frame sent from the first client device and the second video frame received by the second client device may comprise identifying an interception of data between the first client device and the second client device.

According to a disclosed embodiment, determining the security status of the communication session may comprise determining that the video call is an untrusted video call.

According to a disclosed embodiment, the operations may further comprise marking the video call on a graphical user interface of a client device.

According to a disclosed embodiment, the security action may comprise at least one of limiting a user action during the communication session or suspending the communication session.

According to a disclosed embodiment, the security action may comprise prompting at least one participant of the communication session with a request to authenticate an identity of the at least one participant through a multi-factor authentication system.

According to a disclosed embodiment, the security action may comprise rotating a secret associated with a network identity participating in the communication session.

According to a disclosed embodiment, the security action may comprise revoking or suspending at least one permission associated with a network identity participating in the communication session.

The disclosed embodiments may further describe a computer implemented method for securing a real time communication session between at least two computing devices. For example, in an embodiment, a computer-implemented method for securing a real time communication session between at least two computing devices may include operations that may comprise receiving, by an organizational identity service comprising a plurality of pre-registered network identities associated with an organization, data from a software agent associated with a communication application running on a computing device associated with at least one of the plurality of pre-registered network identities, the data corresponding to a real-time communication session being performed between at least two network identities associated with the organizational identity service, identifying, by the organizational identity service, an authentication request from a first participant of the communication session, wherein the authentication request comprises selecting a name, a role, or a picture of a second participant of the communication session through a graphical user interface associated with the communication application, triggering, based on the authentication request, a prompt associated with a security policy of the organization to authenticate the second participant of the communication session during the communication session, and displaying, through a graphical user interface associated with the first participant, a response to the authentication request.

According to a disclosed embodiment, the prompt for authentication of the second participant of the communication session may be displayed through a graphical user interface associated with the second participant.

According to a disclosed embodiment, the response may comprise a display on the graphical user interface that the second participant is an authenticated user of the organizational identity service.

According to a disclosed embodiment, the response may comprise a display on the graphical user interface that the second participant is not an authenticated user of the organizational identity service.

According to a disclosed embodiment, the prompt may include at least one of text, a picture, or media to the authentication request, and wherein the text, the picture, or the media are associated with a context of the communication session.

According to a disclosed embodiment, the prompt may include a request to input a number, a letter, or a symbol displayed in the communication session.

According to a disclosed embodiment, the operations may further comprise determining a security status of the second participant based on the input.

According to a disclosed embodiment, the prompt may be sent from the first participant to the second participant through the organizational identity service.

According to a disclosed embodiment, the authentication request may be sent from the first participant directly to the second participant.

Aspects of the disclosed embodiments may include tangible computer readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments.

### BRIEF DESCRIPTION OF THE DRAWINGS

The accompanying drawings, which are incorporated in and constitute a part of this specification, illustrate disclosed embodiments and, together with the description, explain the disclosed embodiments.

FIG. 1 is a block diagram of a system for securing a real time communication session between at least two computing devices, in accordance with disclosed embodiments.

FIG. 2 is a block diagram of a computing device for securing a real time communication session between at least two computing devices, in accordance with disclosed embodiments.

FIG. 3 is a flowchart of a process for securing a real time communication session between at least two computing devices, in accordance with disclosed embodiments.

FIG. 4 is a block diagram of a process for securing a real time communication session between at least two computing devices, in accordance with disclosed embodiments.

FIG. 5 is a flowchart of a process for securing a real time communication session between at least two computing devices, in accordance with disclosed embodiments.

### DETAILED DESCRIPTION

In the following detailed description, numerous specific details are set forth to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently.

The techniques for securing a real time communication session between at least two computing devices described herein overcome several technological problems relating to the security of real time communication sessions. In particular, the disclosed embodiments provide techniques for monitoring real time communication sessions and validating the security status of the real time communication session. As discussed above, current communication sessions may not provide a user authentication system to fully validate the authenticity and security of each user on a communication session.

The disclosed embodiments provide technical solutions to these and other problems arising from current techniques. For example, various disclosed techniques provide increased security to real time communication sessions by monitoring the communication session, validating the communication session, determining a security status of the communication session, and performing a security action based on the security status. The disclosed techniques may analyze the content of the communication session, data from an agent, a communication profile of a participant of the communication session, and/or at least one secret associated with a participant of the communication session. In other embodiments, the disclosed techniques may allow a participant in a communication session to send an authentication request which may prompt another participant on a communication session to validate its network identity. Such techniques may increase the security of a communication session by allowing participants of the communication session to generate authentication requests and receive a response to the authentication request in real time through a graphical user interface associated with the communication session.

Reference will now be made in detail to the disclosed embodiments, examples of which are illustrated in the accompanying drawings.

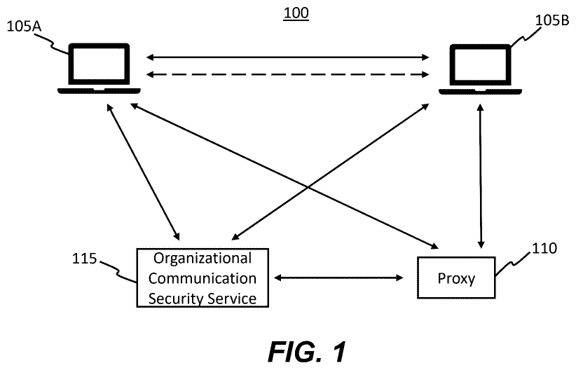

FIG. 1 depicts an exemplary system 100 for securing a real-time communication session between at least two computing devices. For example, computing device 105A and computing device 105B may participate in a communication session, such as a video call or an audio call. Although FIG. 1 depicts two computing devices, any number of computing devices may participate in a communication session.

While participating in a real-time communication session, each of computing device 105A and computing device 105B may communicate transparently with organizational communication security service 115, which in some embodiments may be implemented as a proxy, such as proxy 110. In other embodiments, organizational communication security service 115 may be implemented as code running on computing device 105A and/or computing device 105B, as disclosed herein. For example, organizational communication security service 115 may be implemented as an add-on to a communication service software, a browser extension, an agent, or other implementations.

In some embodiments, organizational communication security service 115 may include, as a non-limiting example, an identity threat detection and response (“ITDR”) system, an endpoint detection and response (“EDR”) system, an identity threat detection (“ITD”) system, an extended detection and response (“XDR”) system, or any other security service for securing a real-time communication session between at least two devices. In some embodiments, organizational communication security service 115 may operate in the background of computing device 105A and/or computing device 105B to validate the authenticity and security of the communication session. In other embodiments, organizational communication security service 115 may be run through a network associated with computing device 105A and/or computing device 105B. In some embodiments, organizational communication security service 115 may be run in a cloud environment, an on-premises environment, or a combination of both. In some embodiments, organizational communication security service 115 may include a backend and frontend layer. In other embodiments, organizational communication security service 115 may only include a backend layer, without an associated frontend graphical user interface.

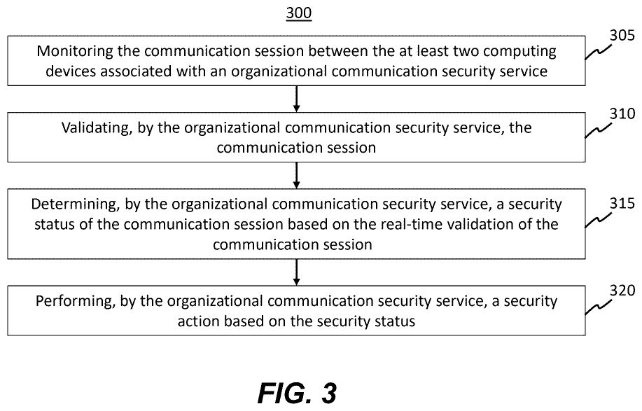

Organizational communication security service 115 may monitor the communication session and validate the communication session based on the content of the communication session and at least one of data from an agent installed on at least one of the at least two computing devices, a comparison to a communication profile associated with at least one network identity participating in the communication session, or at least one secret associated with the at least one network identity participating in the communication session, as disclosed herein with respect FIG. 3. Further, organizational communication security service 115 may determine a security status of the communication session in real time and perform a security action based on the security status, as disclosed herein with respect to FIG. 3.

In some embodiments, the network identities associated with computing device 105A and computing device 105B may be registered with organizational communication security service 115, which may be implemented as a proxy, such as proxy 110. Proxy 110 may facilitate transparent communication between computing device 105A or computing device 105B and organizational communication security service 115. Proxy 110 may comprise a system, application, or other resource that may provide an intermediary connection between computing device 105A or computing device 105B and organizational communication security service 115. For example, proxy 110 may be configured to monitor and process requests and other communications between computing device 105A or computing device 105B and organizational communication security service 115. Proxy 110 may be a hardware proxy or a software proxy. For example, a hardware proxy may be between computing device 105A or computing device 105B and organizational communication security service 115 to receive (e.g., intercept or directly receive), assess (e.g., parse communications headers, payload, etc.), send, and forward requests. A software proxy may be accommodated through a network resource provider or may exist in the cloud. Proxy 110 may be a forward proxy, a reverse proxy, a web proxy server, an anonymous proxy, a high anonymity proxy, a transparent proxy, a distorting proxy, or any other form of proxy that provides communication between computing device 105A or computing device 105B and organizational communication security service 115. In some embodiments, organizational communication security service 115 may be implemented using a proxy, such as proxy 110, to transparently monitor and validate communication sessions between computing device 105A and computing device 105B without additional input from a user.

In some embodiments, the network identities associated with computing device 105A and computing device 105B may be registered through a Software as a Service (“Saas”) System. The SaaS system may include a cloud-based model that may allow the network identities to access software applications over the internet. The SaaS system may facilitate transparent communication between computing device 105A or computing device 105B and organizational communication security service 115. In other embodiments, the network identities associated with computing device 105A and computing device 105B may be registered with an identity provider (“IdP”). The IdP may store and manage digital identities for users and may authenticate an entity connecting to a network or a system. The IdP may allow computing device 105A and computing device 105B to transparently communicate with organizational communication security service 115 by managing and authenticating the digital identities associated with computing device 105A and computing device 105B.

In some embodiments, the various components described herein may communicate over a network. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. In other embodiments, the disclosed systems and methods may also be used in a localized system, with one or more of the components communicating directly with each other.

Computing devices 105A and 105B may be a variety of different types of computing devices capable of developing, storing, analyzing, and/or executing software code. For example, computing device 105A and computing device 105B may be a personal computer (e.g., a desktop or laptop), an IoT device (e.g., sensor, smart home appliance, connected vehicle, etc.), a server, a mainframe, a vehicle-based or aircraft-based computer, a virtual instance (e.g., virtualized computer, a software container, serverless function etc.), or the like. Computing device 105A and computing device 105B may be a handheld device (e.g., a mobile phone, a tablet, or a notebook), a wearable device (e.g., a smart watch, smart jewelry, an implantable device, a fitness tracker, smart clothing, a head-mounted display, etc.), an IoT device (e.g., smart home devices, industrial devices, etc.), or various other devices capable of processing and/or receiving data. Computing device 105A and computing device 105B may operate using a Windows™ operating system, a terminal-based (e.g., Unix or Linux) operating system, a cloud-based operating system (e.g., through AWS™, Azure™, IBM Cloud™, etc.), or other types of non-terminal operating systems.

System 100 may further comprise one or more database(s), for storing and/or executing software. For example, the database may be configured to store software or code, such as code developed using computing device 105A and computing device 105B. The database may further be accessed by computing device 105A, computing device 105B, a server, or other components of system 100 for downloading, receiving, processing, editing, or running the stored software or code. The database may be any suitable combination of data storage devices, which may optionally include any type or combination of databases, load balancers, dummy servers, firewalls, back-up databases, and/or any other desired database components. In some embodiments, the database may be employed as a cloud service, such as a Software as a Service (SaaS) system, a Platform as a Service (PaaS), or Infrastructure as a Service (IaaS) system. For example, the database may be based on infrastructure or services of Amazon Web Services™ (AWS™), Microsoft Azure™, Google Cloud Platform™, Cisco Metapod™, Joyent™, vmWare™, or other cloud computing providers. The database may include other commercial file sharing services, such as Dropbox™, Google Docs™, or iCloud™. In some embodiments, the database may be a remote storage location, such as a network drive or server in communication with the network. In other embodiments, the database may also be a local storage device, such as local memory of one or more computing devices (e.g., computing device 105A or computing device 105B) in a distributed computing environment.

System 100 may also comprise one or more server device(s) in communication with a network. The server device may manage the various components in system 100. In some embodiments, the server device may be configured to process and manage requests between computing device 105A, computing device 105B, and/or the databases. In embodiments where software code is developed within system 100, the server device may manage various stages of the development process, for example, by managing communications between computing device 105A, computing device 105B, and/or the databases over a network. The server device may identify updates to code in the database, may receive updates when new or revised code is entered in the database, and may participate in securing a real time communication session between at least two computing devices as discussed below in connection with FIGS. 3-5.

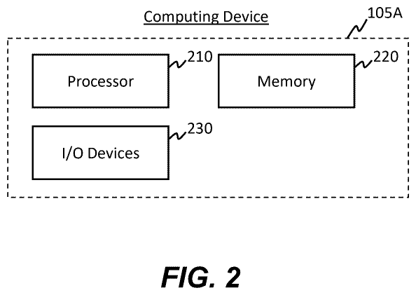

FIG. 2 is a block diagram showing a computing device, such as computing device 105A, in accordance with disclosed embodiments. Computing device 105A may include a processor (or processors) 210. Processor (or processors) 210 may include one or more data or software processing devices. For example, processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. Processor 210 may also be based on the ARM architecture, a mobile processor, or a graphics processing unit, etc. The disclosed embodiments are not limited to any type of processor configured in the computing device 105A.

In some embodiments, computing device 105A may be associated with organizational communication security service 115. Organizational communication security service 115 may be included in computing device 105A. For example, organizational communication security service 115 may be implemented as code running on computing device 105A, as disclosed herein. Organizational communication security service 115 may be implemented as an add-on to a communication service software, a browser extension, an agent, or other implementations Alternatively, organizational communication security service 115 may be employed as a cloud service, such as a Software as a Service (SaaS) system, a Platform as a Service (PaaS), or Infrastructure as a Service (IaaS) system. In some embodiments, organizational communication security service 115 may run on a computing resource managed by an organization (i.e., on a computing device or cloud managed by an organization). In other embodiments, organizational communication security service 115 may run on a computing resource managed externally by a third party. For example, organizational communication security service 115 may be based on infrastructure of services of Amazon Web Services™ (AWS™), Microsoft Azure™, Google Cloud Platform™, Cisco Metapod™, Joyent™, vmWare™, or other cloud computing providers.

Memory (or memories) 220 may include one or more storage devices configured to store instructions or data used by the processor 210 to perform functions related to the disclosed embodiments. Memory 220 may be configured to store software instructions, such as programs, that perform one or more operations when executed by the processor 210 to secure a real time communication session between at least two computing devices, for example, using process 300 or process 500, described in detail below. The disclosed embodiments are not limited to software programs or devices configured to perform dedicated tasks. For example, the memory 220 may store a single program, such as a user-level application, that performs the functions of the disclosed embodiments, or may comprise multiple software programs. Additionally, the processor 210 may in some embodiments execute one or more programs (or portions thereof) remotely located from the computing device 105A. Furthermore, the memory 220 may include one or more storage devices configured to store data (e.g., machine learning data, training data, algorithms, etc.) for use by the programs, as discussed further below.

Computing device 105A may further include one or more input/output (I/O) devices 230. I/O devices 230 may include one or more network adaptors or communication devices and/or interfaces (e.g., WiFi, Bluetooth®, RFID, NFC, RF, infrared, Ethernet, etc.) to communicate with other machines and devices, such as with other components of system 100 through a network. In some embodiments, the I/O devices 230 may also comprise a touchscreen configured to allow a user to interact with organizational communication security service 115 and/or an associated computing device. The I/O device 230 may comprise a keyboard, mouse, trackball, touch pad, stylus, and the like.

FIG. 3 depicts a flowchart of a process 300 for securing a real time communication session between at least two computing devices. Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

Step 305 of process 300 may include monitoring the communication session between the at least two computing devices associated with an organizational communication security service. In some embodiments the communication session may be a video call, an audio call, or any other form of communication session. In some embodiments, the organizational communication security service may correspond to organizational communication security service 115, as disclosed herein with respect to FIG. 1. In some embodiments, the organizational communication security service may be implemented on at least one of a cloud environment, at least one computing device participating in the communication session, an add-on to a computer program associated with the communication session, or a browser component. In some embodiments, the at least two computing devices may correspond to computing device 105A and computing device 105B, as disclosed herein with respect to FIG. 1. The organizational communication security service may transparently monitor the communication session, such that a user participating in the communication session through a computing device may not be aware of the operations of the organizational communication security service. Monitoring the communication session may include receiving, in real time, the audio and/or video content of the communication session. Monitoring the communication session may further include monitoring the status of a communication session, whether a computing device initiated or received an invitation to join a communication session, monitoring the content of the communication session, determining a location of the computing devices participating in the communication session, or monitoring any other data or content associated with the communication session.

Step 310 of process 300 may include validating, by the organizational communication security service, the communication session. The communication session may be validated based on an analysis of the content of the communication session and at least one of data from an agent installed on at least one of the at least two computing devices, a comparison to a communication profile associated with at least one network identity participating in the communication session, or at least one secret associated with the at least one network identity participating in the communication session.

The content of the communication session may include any substantive discussion, conversation, or other exchange of information (verbal, written, etc.) between participants of the communication session. The content of the communication session may be analyzed using a pre-trained machine learning model. A pre-trained machine learning model may be any system, device, component, program, script, or the like, for analyzing the content of a communication session. For example, in some embodiments, the pre-trained machine learning model may comprise a large language model such as OpenAI ChatGPT™, Meta LLaMA™, Microsoft Copilot™, Google Gemini™, Anthropic Claude™, or any other type of model or operation associated with a natural language. The pre-trained machine learning model may be in any desired form, such as a statistical model (e.g., a word n-gram language model, an exponential language model, or a skip-gram language model) or a neural model (e.g., a recurrent neural network-based language model or a LLM). In some examples, the pre-trained machine learning model may include a LLM with artificial neural networks, transformers, and/or other desired machine learning architectures. The pre-trained machine learning model may be trained using, for example, supervised learning, self-supervised learning, semi-supervised learning, unsupervised learning, and/or reinforcement learning. In some examples, the pre-trained machine learning model may be pre-trained to generally understand a natural language. In some examples, the pre-trained machine learning model may include generative pre-trained transformers (GPT) or other types of generative artificial intelligence configured to generate human-like content. Analyzing the communication session may include using content data associated with at least one participant of the communication in combination with the pre-trained machine learning model. For example, the content data may include a statement that may be verbally communicated during the communication session or communicated in writing during the communication session. The content data may be transmitted as input to the pre-trained machine learning model.

As an example, in some embodiments, analyzing the content of the communication session through a pre-trained machine learning model may comprise enforcing an organizational security policy. The pre-trained machine learning model may analyze the content data to identify one or more violations of an organization's security policy. For example, the pre-trained machine learning model may determine that the content data transmitted during a communication session includes an exchange of personal identifiable information, financial information, or other confidential information in violation of the organization's security policy. In some embodiments, the organization may have a set of pre-determined guidelines or rules regarding the types of content data that may violate the security policy. In other embodiments, the pre-trained machine learning model may intelligently analyze the content data to infer malicious intent in the exchange of information during the communication session. In such an embodiment, the pre-trained machine learning model may not have a strict set of guidelines or rules to determine whether content data violates a security policy. Rather, the pre-trained machine learning model may make inferences regarding a security violation or potential malicious exchanges of information based on the content data.

In other embodiments, analyzing the content of the communication session may include comparing a first video frame sent from a first client device and a second video frame received by a second client device. In some embodiments, comparing the first video frame to the second video frame may identify an interception and manipulation of data between the first client device and the second client device. For example, if the first video frame sent from the first client device does not match the second video frame received by the second client device, then it may be determined that the first video frame may have been intercepted and manipulated during transmission. Identifying a manipulation in the video frames of a video communication session may allow the organizational communication security service to determine that the communication session may not be secure.

In some embodiments, the organizational communication security service may further analyze data from an agent installed on at least one of the at least two computing devices. The agent installed on at least one of the computing devices may comprise a browser component or an endpoint management software. For example, in some embodiments, the communication session may be initiated through a web browser operating on the computing device. The agent may include a browser component, such as a browser extension that allows custom functionality to a browser. The agent may monitor, collect, and transmit data from the communication session conducted through the web browser. In other embodiments, the agent may include an endpoint management software, which may include a software component that may manage and secure devices connected to an organization's network. For example, in some embodiments, the communication session may be initiated through a web browser or through a third-party application. The endpoint management software may enforce an organization's security policies by collecting, monitoring, and transmitting data from the communication session that may be initiated over a web browser or third-party application.

In some embodiments, analyzing data from the agent may include verifying that the communication session was initiated from an approved user's computing device. For example, a plurality of users associated with an organization may be pre-registered with the organizational communication security service, such as organizational communication service 115. The organizational communication security service may compare data regarding the initiated call received from the agent (such as the location in which the communication session was initiated, the IP address of the computing device initiating the communication session, etc.) to validate whether or not the communication session was initiated by an authorized pre-registered user.

In other embodiments, analyzing data from an agent may include using metadata from the one or more computing device to validate the security of the communication session. The metadata may include data regarding the location of the computing device at the time of the communication session, the use of other software components during the communication session, or data associated with an identity service. For example, if the metadata of a communication session indicates that the communication session was initiated from a different geolocation than a geolocation that have been previously associated with a network identity, then the organizational communication security service may query a profile associated with the network identity to confirm whether a user associated with the network identity initiating the communication session is in fact deviating from its ordinary geolocation at that time. In another example, the organizational communication security service may analyze the metadata associated with the communication session to confirm that the user is initiating the communication session through approved channels (e.g., Teams, Zoom, Outlook, etc.).

In other embodiments, analyzing data from the agent may include using an out-of-band verification to authenticate the identity of the user. An out-of-band verification may use a communication channel separate from the communication session to verify a user's identity. For example, the out-of-band verification may include signing the video frames or audio stream of the communication without interrupting the original communication session, or other techniques. The out-of-band verification may provide a secondary verification method outside of the communication session to confirm the security and authenticity of the communication session.

In other embodiments, analyzing the data from the agent may include the validation of the bits layer (i.e., raw data that is represented in bits) that is produced for exchange between computing devices during the communication session. The bit-layer validation may be performed prior to the encryption of the session data. Accordingly, the validation process is adaptable and applicable across various communication protocols (e.g., video and audio) and communication platforms (e.g., Teams, Zoom, Meet, Slack, FaceTime, WhatsApp, etc.).

In another embodiment, analyzing data from the agent may include validating the physical presence of the user participating in the communication session. For example, the agent may collect data from any sensor or sub-device utilized accessible in the computing device, such as the camera, microphone, accelerometer, or location service to verify a physical location of the user participating in the communication session. The agent may further correlate location information with external sensors. For example, the organizational communication security service may use facility-based data (such as data indicating that a user has entered a building, a user has entered a parking structure, a user has operated a particular machine, etc.) to confirm the physical location of the user participating in the communication session. In some embodiments, the agent may compare the physical location of the user participating in the communication session with a location identified by the IP address of the user. For example, the physical location of the user may be identified using any sensor or sub-device associated with the user device or using facility-based data. The physical address of the user may be compared to the location identified by the IP address of the user. In other embodiments, when the user is located at a facility of the organization, the IP address of the user may be compared to the IP address of the organization associated with the organization's network.

The organizational communication security service may also conduct a comparison to a communication profile associated with at least one network identity participating in the communication session. As disclosed herein, users associated with an organization may be registered with the organizational communication security service, an agent, or an identity provider. Registration of the user may allow the organizational communication security service to verify whether the network identity participating in the communication session is associated with the organization. For example, the organizational communication security service may analyze historical data associated with the network identity, such as past logins, past calls, network activity, and other historical data. The organizational communication security service may further analyze organizational attributes of the network identity, such as the role, groups, position, and associations of the network identity within the organization.

The organizational communication security service may further validate at least one secret associated with at least one network identity participating in the communication session. The secret associated with the network identity may comprise a token, a password, a key, or any other privileged credentials associated with the network identity. In some embodiments, the network identity or the computing device may present a secret for authentication when initiating or participating in a communication session. The organizational communication security service may validate the secret to determine when the secret was assigned and if the secret was rightfully assigned. For example, the organizational communication security service may confirm whether the secret has been manipulated by determining when the secret was assigned and if it was rightfully assigned. In other embodiments, a third-party identity authentication service, such as an IdP, may validate the authenticity of the secret presented by the network identity during the communication session.

Step 315 of process 300 may include determining, by the organizational communication security service, a security status of the communication session based on the real-time validation of the communication session. The security status of the communication session may include a score (e.g., 0-10), a rank (e.g., trusted session, untrusted session), a level (e.g., low risk, medium risk, or high risk), or any other status indicator of the security of the communication session. The organizational communication security service may analyze the results of the real-time validation of the communication session to determine the security status of the communication session. For example, the organizational communication security service may determine that a communication session is conducted between two computing devices connected to an organizational LAN network. In such an instance, the organizational communication security service may determine that the security status of the communication session is low risk. In another non-limiting example, the organizational communication security service may determine that a communication session is being conducted through a mobile device in a geographic location that differs from a user profile associated with the participant of the communication session. In such an instance, the organizational communication security service may determine that the security status of the communication session is high risk.

Step 320 of process 300 may include performing, by the organizational communication security service, a security action based on the security status. In some embodiments, if the security status indicates that the communication session is secure or a low-risk communication session, then the security action may comprise taking no action regarding the communication session. For example, the organizational communication security service may continue to monitor the communication session transparently but may not take any security action throughout the call. In other embodiments, if the security status indicates that the communication session is not secure or is a high-risk communication session, then the organizational communication security service may take a positive security action. In some embodiments, the security action may include limiting a user action during the communication session or suspending the communication session. Limiting a user action may include muting the microphone of at least one participant of the communication session, preventing at least one participant from providing a written response (e.g., a chat, an instant message, an email, etc.) to another participant, preventing at least one participant from sharing a file or data, turning off the camera of at least one participant of the communication session, preventing a participant from taking screen shots during the communication session, freezing at least one participant (e.g., pausing their audio and/or video), sending a message or an instruction to a third-party application or service (e.g., a banking application, a payroll application, or any other complementary application or service) to prevent the user from completing an action in the third-party application or service, or any other limitation of user actions. Suspending the communication session may include pausing the communication session between all participants, terminating the communication session between all participants, terminating the communication session of fewer than all participants, or any other suspension of the communication session.

In some embodiments, the security action may include prompting at least one participant of the communication session with a request to authenticate the identity of the at least one participant through a multi-factor authentication system. For example, the security action may include sending a push notification, a text message, an email, or any other prompt to the at least one participant to authenticate the network identity of the at least one participant. The multi-factor authentication system may include an out-of-band verification of the participant's identity. For example, the multi-factor authentication system may use a separate communication channel from the communication session to verify the identity of the participant. The multi-factor authentication system may provide a secondary verification of the identity of at least one participant in the communication session. If the participant of the communication session does not verify its identity through the multi-factor authentication system, then the organizational communication security system may limit the participant's actions during the communication session or may terminate the communication session.

In some embodiments, the security action may include rotating a secret associated with a network identity participating in the communication session. Rotating a secret associated with a network identity may include generating a new secret for the network identity, distributing the new secret to target network environments, and disabling or decommissioning the prior secret. The secret may be rotated by a central management system, a secret rotation manager, the organizational communication security service, or any other component.

In some embodiments, the security action may include revoking or suspending at least one permission associated with a network identity participating in the communication session. Revoking or suspending at least one permission may include preventing the at least one network identity from accessing other secure network resources, programs, software, or other components. For example, the permissions to access secure network resources may be revoked or suspended until the network identity has provided a multi-factor authentication or until a secret associated with the network identity has been rotated.

In other embodiments, the security action may include alerting an administrative user associated with at least one participant of the communication session that the communication may be unsecure. The administrative user may take additional action to suspend or terminate the communication session, prompt a multi-factor authentication, dynamically update a permission associated with one or more participant of the communication session, or any other additional security actions. The security action may further include recording the communication session. The recording of the communication session may be transmitted to an administrative user or any other user to review the recording and determine if additional security actions should be taken.

In some embodiments, the security action may further include marking the video call on a graphical user interface of at least one of the computing devices participating in the communication session. For example, a graphical user interface presenting the communication session to a participant may be marked with a green or red square. In some embodiments, if the communication session is validated as a trusted communication session, the graphical user interface may be updated to include a green box around the communication session, a green check mark within the communication session, or any other display that indicates that the communication session is secure. If the communication session is determined to be unsecure or untrusted, then the graphical user interface may be updated to include a red box around the communication session, a red “X” mark within the communication session, or any other display that may indicate that the communication session may not be secure. In other embodiments, the graphical user interface may be paused, frozen, or updated to display a watermark or other indication that the communication session may not be secure.

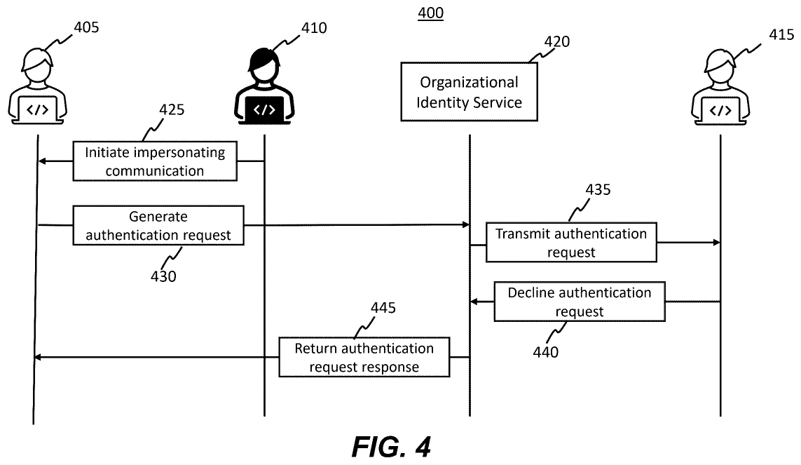

FIG. 4 depicts a process 400 for securing a real time communication session between at least two computing devices. As depicted in FIG. 4, at step 425 of process 400, attacker 410 may initiate an impersonating communication session with first user 405. Attacker 410 may impersonate second user 415, who may be an authorized user of an organizational identity service, such as organizational identity service 420. For example, in some embodiments, a plurality of users such as user 405 and user 415 may be pre-registered with an organizational identity service that may manage, verify, and secure network identities associated with an organization. In some embodiments, the communication session may include a video call, an audio call, a chat, or any other form of communication. At step 430 of process 400, first user 405 may generate an authentication request. The authentication request may include a request to verify an identity of the user that initiated the communication session. The authentication request may be transmitted to organizational identity service 420. Organizational identity service 420 may correspond organizational communication security service 115, as disclosed herein. At step 435 of process 400, organizational identity service 420 may transmit the authentication request to second user 415. The authentication request may be transmitted to second user 415 by a push notification, a text message, an email, a phone call, or by any other method of transmission. At step 440 of process 400, second user 415 may decline the authentication request. In other embodiments in which second user 415 did initiate a communication session, second user 415 may accept the authentication request. At step 445 of process 400, organizational identity service 420 may return the authentication request response to first user 405. Returning the authentication request response may include notifying first user 405 that second user 415 declined or accepted the authentication request. If second user 415 declined the authentication request, first user 405 may then take a security action, such as terminating the communication session, in response to the authentication request response. If second user 415 accepted the authentication request, then first user 405 may not need to take any additional security action.

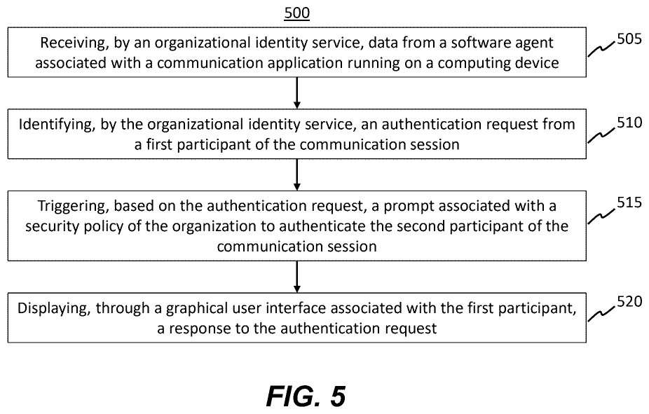

FIG. 5 depicts a flowchart of process 500 for securing a real time communication session between at least two computing devices. Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Step 505 of process 500 may include receiving, by an organizational identity service, data from a software agent associated with a communication application running on a computing device. In some embodiments, the organizational identity service may comprise an access management service or identity provider that may manage and verify user digital identities for users associated with an organization. The organizational identity service may authenticate users directly and provide authentication services to third-party websites and applications. In some embodiments, the organizational identity service may include a plurality of pre-registered network identities that may be associated with an organization. The organizational identity service may allow users within an organization to verify and authenticate other pre-registered users associated with the same organization. The software agent may include an add-on or plugin that may be associated with a communication application. For example, in some embodiments, the software agent may comprise a plugin for a communication application such as the videoconference software Zoom™, and Microsoft Teams™, or any other communication application dedicated to audio and/or video communication. The data received from the software agent may include data corresponding to a real-time communication session being performed between at least two network identities associated with the organizational identity service. For example, the data may include data related to the content of the communication session and metadata associated with the communication session.

Step 510 of process 500 may include identifying, by the organizational identity service, an authentication request from a first participant of the communication session. In some embodiments, the first participant of the communication session may select a name, a role, a picture, or any other identifier of a second participant of the communication session. The user may select the identifier of the second participant through a graphical user interface associated with the communication application. For example, the graphical user interface may include a display through the communication application that may allow the first participant to select a second participant based on a visual identifier, such as a name, a role, or a picture. The authentication request may include a request to confirm or verify the identity of the second participant.

The organizational identity service associated with the communication application may be configured to prompt identity validation automatically when a user begins a call or meeting through the communication application and/or under specific circumstances. For example, the communication application may monitor and manage meeting events, including when a participant joins or leaves a meeting or call, active speaker detection, and participant engagement levels in calls or meetings. The organizational identity service may prompt identity validation if a participant joins a meeting or call from an unfamiliar device or location. For example, the communication application may monitor the devices and locations that a participant uses to join calls and meetings. If the participant joins a call or meeting from an unfamiliar device or location, then the organizational identity service may prompt identity validation of the participant. The organizational identity service may also prompt re-validation of a participant if the participant has been idle or inactive in the communication application for a period of time. The organizational identity service may also prompt identity validation of a participant based on sudden changes in participant behavior, such as increased engagement or accessing sensitive information.

Step 515 of process 500 may include triggering, based on the authentication request, a prompt associated with a security policy of the organization to authenticate the second participant of the communication session during the communication session. Triggering a prompt may include transmitting or otherwise sending the prompt to a computing device associated with the second participant. The prompt may include a push notification, a text message, a phone call, an email, a display on a graphical user interface of a computing device associated with the second participant, or any other form of notification. In some embodiments, the prompt may be transmitted to the second participant through a communication channel that differs from the communication session. In some embodiments, the prompt may include a request to verify the identity of the second participant. In other embodiments, the prompt may include a request to verify that the second participant is participating in the communication session. The prompt may be transmitted to the second participant in real time during the communication session.

In some embodiments, the prompt may include at least one of text, a picture, or media associated with the context of the communication session. For example, the prompt may include text identifying the subject of the communication session, a screenshot of the communication session, or other media related to the communication session. Providing specific information regarding the context of the communication session to the second user in the prompt may allow the second user to accurately determine whether or not to accept or decline the prompt.

In some embodiments, the prompt may include a request to input a number, a letter, or a symbol displayed through a graphical user interface associated with the communication session. For example, the communication session may include a display through a graphical user interface of one or more numbers, letters, or symbols. The prompt may include a request to input the numbers, letters, or symbols that are displayed on the graphical user interface associated with the communication session. The organizational identity service may then determine a security status of the second participant based on the input. The security status of the second participant may include a score (e.g., 0-10), a rank (e.g., trusted identity, untrusted identity), a level (e.g., low risk, medium risk, or high risk), or any other status indicator of the security of the second participant. If the second participant enters the correct numbers, letters, or symbols then the security status of the second participant may be determined to be low risk. If the second participant does not enter the correct numbers, letters, or symbols then the security status of the second participant may be determined to be high risk. In some embodiments, the prompt may be sent from the first participant to the second participant through the organizational identity service. In other embodiments, the prompt may be sent directly from the first participant to the second participant outside of the organizational identity service.

Step 520 of process 500 may include displaying, through a graphical user interface associated with the first participant, a response to the authentication request. When the second participant receives the prompt from the organizational identity service, the second participant may accept or decline the prompt. If the second user is participating in the communication session, the participant may accept the prompt to confirm and verify the second participant's identity. If the second user is not participating in the communication session, then the second user may decline the prompt. The organizational identity service may present the positive or negative response through a graphical user interface associated with the first participant that sent the authentication request. For example, the response may include a display on the graphical user interface that the second participant is an authenticated user of the organizational identity service. If the second participant is an authenticated user, then the display may include a green border around the second participant in the communication session, a green check mark on the display of the second participant in the communication session, or any other visual identifier that the second participant is a verified participant. In some embodiments, the response may include a display on the graphical user interface that the second participant is not an authenticated user of the organizational identity service. If the second participant is not an authenticated user, then the display may include a red border around the second participant in the communication session, a red “X” mark on the display of the second participant in the communication session, or any other visual identifier that the second participant is not a verified participant. If the second participant is not an authenticated user, then the first participant may take a security action, such as terminating the communication session, removing the second participant from the communication session, or any other security action disclosed herein.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A non-transitory computer readable medium including instructions that, when executed by at least one processor, cause the at least one processor to perform operations for securing a real time communication session between at least two computing devices, the operations comprising:
monitoring the communication session between the at least two computing devices associated with an organizational communication security service;
validating, by the organizational communication security service, the communication session based on an analysis of content of the communication session and at least one of: data from an agent installed on at least one of the at least two computing devices, a comparison to a communication profile associated with at least one network identity participating in the communication session, or at least one secret associated with the at least one network identity participating in the communication session;
determining, by the organizational communication security service, a security status of the communication session based on the real-time validation of the communication session; and
performing, by the organizational communication security service, a security action based on the security status.

2. The non-transitory computer readable medium of claim 1, wherein the analysis of the content of the communication session comprises analyzing the content of the communication session using a pre-trained machine learning model.

3. The non-transitory computer readable medium of claim 2, wherein the analysis of the content of the communication session further comprises using context data associated with at least one participant of the communication session in combination with the pre-trained machine learning model.

4. The non-transitory computer readable medium of claim 2, wherein analyzing the content of the communication session comprises enforcement of an organizational security policy.

5. The non-transitory computer readable medium of claim 1, wherein the agent comprises one of a browser component or an endpoint management software.

6. The non-transitory computer readable medium of claim 1, wherein the organizational communication security service is implemented on at least one of: a cloud environment, at least one computing device of the at least two computing devices, the agent, an add-on to a computer program associated with the communications session, or a browser component.

7. The non-transitory computer readable medium of claim 1, wherein validating the at least one secret comprises determining when the at least one secret was assigned and if the at least one secret is rightfully assigned.

8. The non-transitory computer readable medium of claim 1, wherein the communication session is a video call.

9. The non-transitory computer readable medium of claim 8, wherein the analysis of the content of the communication session comprises comparing a first video frame sent from a first client device and a second video frame received by a second client device.

10. The non-transitory computer readable medium of claim 9, wherein comparing the first video frame sent from the first client device and the second video frame received by the second client device comprises identifying an interception of data between the first client device and the second client device.

11. The non-transitory computer readable medium of claim 8, wherein determining the security status of the communication session comprises determining that the video call is an untrusted video call.

12. The non-transitory computer readable medium of claim 11, wherein the operations further comprise marking the video call on a graphical user interface of a client device.

13. A computer implemented method for securing a real time communication session between at least two computing devices, the operations comprising:
monitoring the communication session between the at least two computing devices associated with an organizational communication security service;
validating, by the organizational communication security service, the communication session based on an analysis of content of the communication session and at least one of: data from an agent installed on at least one of the at least two computing devices, a comparison to a communication profile associated with at least one network identity participating in the communication session, or at least one secret associated with the at least one network identity participating in the communication session;
determining, by the organizational communication security service, a security status of the communication session based on the real-time validation of the communication session; and
performing, by the organizational communication security service, a security action based on the security status.

14. The computer implemented method of claim 13, wherein the security action comprises at least one of limiting a user action during the communication session or suspending the communication session.

15. The computer implemented method of claim 13, wherein the security action comprises prompting at least one participant of the communication session with a request to authenticate an identity of the at least one participant through a multi-factor authentication system.

16. The computer implemented method of claim 13, wherein the security action comprises rotating a secret associated with a network identity participating in the communication session.

17. The computer implemented method of claim 16, wherein the security action comprises revoking or suspending at least one permission associated with a network identity participating in the communication session.

18. A computer implemented method for securing a real time communication session between at least two computing devices, the operations comprising:
receiving, by an organizational identity service comprising a plurality of pre-registered network identities associated with an organization, data from a software agent associated with a communication application running on a computing device associated with at least one of the plurality of pre-registered network identities, the data corresponding to a real-time communication session being performed between at least two network identities associated with the organizational identity service;
identifying, by the organizational identity service, an authentication request from a first participant of the communication session, wherein the authentication request comprises selecting a name, a role, or a picture of a second participant of the communication session through a graphical user interface associated with the communication application;
triggering, based on the authentication request, a prompt associated with a security policy of the organization to authenticate the second participant of the communication session during the communication session;
displaying, through a graphical user interface associated with the first participant, a response to the authentication request.

19. The computer implemented method of claim 18, wherein the prompt for authentication of the second participant of the communication session is displayed through a graphical user interface associated with the second participant.

20. The computer implemented method of claim 18, wherein the response comprises a display on the graphical user interface that the second participant is an authenticated user of the organizational identity service.

21. The computer implemented method of claim 18, wherein the response comprises a display on the graphical user interface that the second participant is not an authenticated user of the organizational identity service.

22. The computer implemented method of claim 18, wherein the prompt includes at least one of text, a picture, or media to the authentication request, and wherein the text, the picture, or the media are associated with a context of the communication session.

23. The computer implemented method of claim 18, wherein the prompt includes a request to input a number, a letter, or a symbol displayed in the communication session.

24. The computer implemented method of claim 23, further comprising determining a security status of the second participant based on the input.

25. The computer implemented method of claim 18, wherein the prompt is sent from the first participant to the second participant through the organizational identity service.

26. The computer implemented method of claim 18, wherein the authentication request is sent from the first participant directly to the second participant.
